(19) United States
(12) Patent Application Publication
(10) Pub. No.: US 2012/0171448 A1
(43) Pub. Date: Jul. 5, 2012

(54) ORDERED ASSEMBLY OF NANOPARTICLES IN SPATIALLY DEFINED REGIONS

(76) Inventors: Austin Joseph Akey, Hanover, VA (US); Irving Philip Herman, Bronx, NY (US); Chenguang Lu, New York, NY (US)

(21) Appl. No.: 13/291,261

(22) Filed: Nov. 8, 2011

Related U.S. Application Data
(60) Provisional application No. 61/416,929, filed on Nov. 24, 2010.

(51) Int. Cl. B32B 5/16; B05C 7/04; B05D 7/22; B82Y 40/00

(52) U.S. Cl. 428/220; 427/235; 118/50; 118/400; 977/892

(57) ABSTRACT

The disclosed subject matter relates to a method for forming an ordered assembly of nanoparticles in spatially defined regions. The method is based on migration of a dispersion of nanoparticles from a reservoir to a microchannel and controlled evaporation of the solvent in the dispersion to facilitate the formation of the ordered assembly in the microchannel. The disclosed subject matter also relates to an apparatus for preparing ordered assembly of nanoparticles, use of the ordered assembly of nanoparticles in the manufacture of materials and devices, and materials and devices based on or including such ordered assembly of nanoparticles.

### CROSS REFERENCE TO RELATED APPLICATIONS

This application claims priority from U.S. provisional patent application No. 61/416,929, filed Nov. 24, 2010, the disclosure of which is incorporated herein in its entirety.

### STATEMENT REGARDING FEDERALLY FUNDED RESEARCH

This invention was made with government support under grant numbers MRSEC/DMR-0213574 and NSEC/CHE-0641523, both awarded by the National Science Foundation. The government has certain rights in the invention.

### BACKGROUND

Solids or colloidal particles dispersed in a drying drop can migrate to and deposit on the perimeter of the drop and form a ring. This phenomenon is sometimes referred to as the “coffee-ring” phenomenon. The migration of the solids can be caused by an outward flow within the drop driven by the loss of solvent by evaporation and the geometrical constraint that the drop maintain an equilibrium droplet shape with a fixed boundary.

Controlled drying of solutions of monodisperse nanoparticles can produce single- or several-layer superlattices with lateral dimensions up to the millimeter range. Likewise, micrometer-dimension, 3D supercrystals of monodisperse nanoparticles can be formed by extended drying of nanoparticles solutions in beakers (and sometimes collected on substrates).

The formation of varied types of ordered assemblies of nanoparticles holds the promise of new materials with tunable properties that differ from those of disordered assemblies. However, the positioning and size of evaporation-mediated assembled structures are often poorly controlled. For example, the assembled structure can be sensitive to preparation parameters, including temperature, pressure, addition of extra polar molecules/ligands, nanoparticle concentration, etc. This has resulted in poor repeatability and made control of formation difficult due to the complexity and sensitivity of the formation of the ordered assembly to the local environment. Thus, it is desirable to obtain ordered assembly of colloidal nanoparticles having well defined dimension and internal packing order in a controllable manner.

### SUMMARY

In one aspect, the disclosed subject matter provides a method for forming an ordered assembly of nanoparticles. According to this method, a volume of a nanoparticle dispersion, which includes nanoparticles and at least one solvent, is introduced into a reservoir which is in fluidic communication with at least one microchannel. A portion of this nanoparticle dispersion is permitted to move into the at least one microchannel. The evaporation rate of the at least one solvent is controlled to form the ordered assembly of nanoparticles in the at least one microchannel.

In another aspect, the disclosed subject matter provides an apparatus for forming an ordered assembly of nanoparticles in a spatially defined region. The apparatus includes a reservoir for receiving a volume of a nanoparticles dispersion, and at least one microchannel in fluidic communication with the reservoir. The at least one microchannel is configured to effect at least a portion of the nanoparticles in the nanoparticles dispersion received in the reservoir to move into the at least one microchannel and to form an ordered assembly therein.

In a further aspect, the disclosed subject matter provides the ordered assembly of nanoparticles prepared by the above-described techniques, and materials and/or devices based on or including ordered assembly of nanoparticles. These materials and devices include x-ray optical materials, magnetic storage materials, vibration/sonic detection devices, chemical templating material, negative index optical materials, photonic band gap materials, plasmonic waveguides, and magnetoresistive/memristive materials, among others.

### BRIEF DESCRIPTION OF THE DRAWINGS

FIG. 1 depicts a diagram for a method for forming an ordered assembly of nanoparticles according to some embodiments of the presently disclosed subject matter.

FIGS. 2a and 2b depict certain configurations of the reservoir/microchannel according to some embodiments of the presently disclosed subject matter.

FIGS. 3a-3d depict the morphology the top surface of ordered assemblies of nanoparticles prepared according to some embodiments of the presently disclosed subject matter.

FIGS. 4a and 4b depict close-up views of certain local morphology of the top surface of ordered assemblies of nanoparticles prepared according to some embodiments of the presently disclosed subject matter.

FIGS. 5a-5c depict the morphology the selected regions of the top surface of an ordered assembly of Fe₂O₃ nanoparticles prepared according to some embodiments of the presently disclosed subject matter.

FIGS. 6a and 6b depict the morphology and small angle x-ray scattering (SAXS) measurement results for a cross-section of an ordered assembly of Fe₂O₃ nanoparticles prepared according to some embodiments of the presently disclosed subject matter.

FIGS. 7a and 7b depict SAXS characterization of an ordered assembly of Fe₂O₃ nanoparticles prepared according to some embodiments of the presently disclosed subject matter.

FIGS. 8a-8d depict the morphologies of the top surface of various ordered assemblies of Fe₂O₃ nanoparticles prepared by varying certain preparation parameters according to some embodiments of the presently disclosed subject matter.

### DETAILED DESCRIPTION

The disclosed subject matter relates to techniques for forming an ordered assembly of nanoparticles, apparatus for forming an ordered assembly of nanoparticles, use of the ordered assembly of nanoparticles in the manufacturer of materials and devices, and materials and devices based on or including such ordered assembly of nanoparticles. These aspects are described below in connection with a method for forming an ordered assembly of nanoparticles.

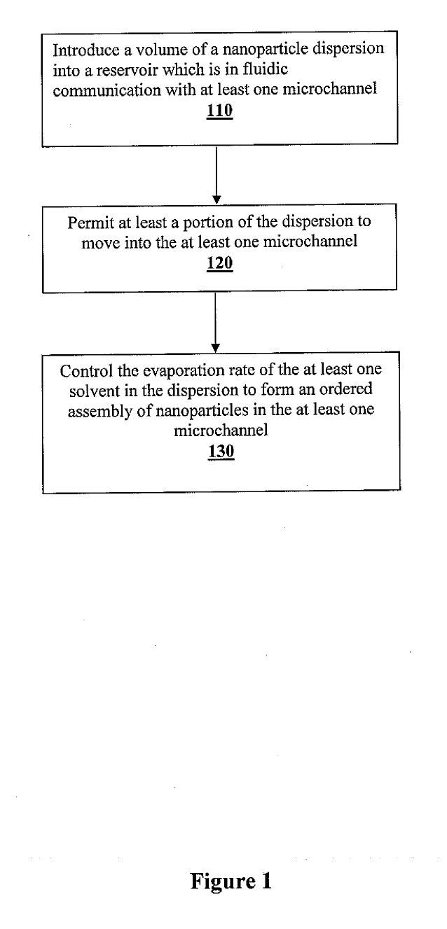

Referring to FIG. 1, an exemplary method for forming an ordered assembly of nanoparticles is provided. The method includes introducing a volume of a nanoparticle dispersion including nanoparticles and at least one solvent into a reservoir which is in fluidic communication with at least one microchannel (at 110); permitting a portion of the nanoparticle dispersion to move into the at least one microchannel (at 120); and controlling the evaporation rate of the at least one solvent to form the ordered assembly of nanoparticles in the at least one microchannel (at 130). The movement of nanoparticle dispersion into the microchannel can occur contemporaneously with the evaporation. Accordingly, 120 and 130 can overlap in time, and the method should be understood as not requiring one to occur before the other.

As used herein, the term “ordered assembly” is used interchangeably with the terms “superlattice(s)”, “ordered film(s)”, “ordered solids”, “supracrystals”, or “supercrystal(s)” of nanoparticles, which refer to an aggregation of nanoparticles having a regular long-range three-dimensional packing order.

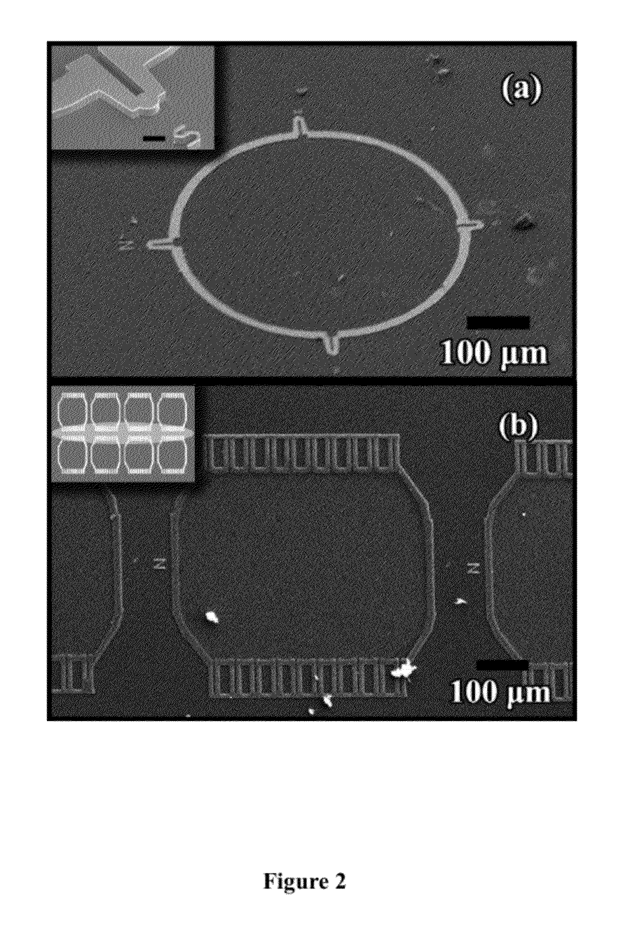

The reservoir and at least one microchannel can be configured in various ways. In some embodiments, the at least one microchannel includes a plurality of microchannels distributed on the periphery of the reservoir. For example and not limitation, as shown in FIG. 2a, a round reservoir of about 500 μm in diameter is connected to several microchannels radially extending from the reservoir perimeter. As illustrated in FIG. 2b, arrays of substantially parallel microchannels are arranged on both sides of a central reservoir. The size of the reservoir can be varied in a wide range. For example, the reservoir can be about two orders of magnitude or larger than the total area of the microchannels to produce multilayered assemblies. In some embodiments, the reservoir is up to about 1 cm². The microchannels each can be of the same depth as the reservoir, for example, from about 0.1 μm to 30 μm, or 1 μm to about 3 μm. The microchannels can have a width of, from example, from about 0.1 μm to about 200 μm, or from about 1 μm to about 8 μm, and a length of, for example, about 1 μm to about 1000 μm, or from about 10 μm to about 100 μm. Introduction of a nanoparticle dispersion into the reservoir can be achieved, for example, by using an microinjector, drop casting, or by other means as known in the art.

The reservoir and the at least one microchannel can be both manufactured by lithography techniques on a suitable substrate. For example, the reservoir and the at least one microchannel can be both manufactured on a silicon wafer by electron beam and/or plasma lithography, as will be illustrated in the Example below. Further, to provide desired entrainment and/or ordered packing of nanoparticles in the microchannel, the hydrophobicity of the nanoparticles and that of the substrate should be considered. For example, for a hydrophobic substrate surface, hydrophobic nanoparticles can be dispersed in a hydrophobic solvent and entrained into the microchannel and form ordered assembly therein.

The nanoparticles useful for the disclosed subject matter include, but are not limited to, metal, metal alloy, metal oxide, inorganic, semiconductor, and other types of nanoparticles, and mixtures or hybrids thereof. The nanoparticles can include core-shell structures composed of different materials. The nanoparticles and their dispersions can be prepared according to commonly known techniques in the art. The nanoparticles can be suitably surface-modified to have improved stability in a dispersion. In some embodiments, the nanoparticles of the disclosed subject matter include Fe₂O₃ nanoparticles and/or CdSe nanoparticles.

The concentration of nanoparticles in the nanoparticle dispersion can affect the time needed for forming ordered assembly of nanoparticles and/or the morphologies of the nanoparticle superlattice formed according to the disclosed techniques. In some embodiments, the nanoparticles can have a concentration of at least about 10¹⁵ nanoparticles/mL of the nanoparticle dispersion. Other suitable concentrations of nanoparticle dispersion can be determined according to, for example, the size and/or configuration of the microchannel, types of nanoparticles, or other conditions.

The nanoparticles suitable for the disclosed subject matter can have an average size of about 1 nm to about 50 nm in diameter, about 2 nm to about 20 nm in diameter, about 3 nm to 14 nm in diameter, or about 5 nm to about 10 nm in diameter.

The nanoparticles suitable for the disclosed subject matter can have various shapes, including spherical, ellipsoidal, rod, etc. The shape of the nanoparticles can affect the speed of the formation of the ordered assembly, as well as the packing density and order of the assembly. In one embodiment, the nanoparticles of the disclosed subject matter have a substantially spherical shape. The distribution of the size of the nanoparticles can also affect the packing order of the assembly. In one embodiment, the nanoparticles of the disclosed subject matter are monodisperse.

The solvent in a nanoparticle dispersion not only provides the necessary medium through which the nanoparticles entrain and concentrate into the microchannels, but is also important for the formation of the superlattice as well as the microstructure of the superlattice. In one embodiment, a suitable solvent can have high solubility for the nanoparticles, allow for flow into the channel before significant evaporation and allow slow enough solvent evaporation to obtain desired order of the nanoparticles, or can have one or more of these properties. For example, a solvent can have a boiling point at atmospheric pressure of about 200° C. or higher. The surface properties of the nanoparticles, accordingly, should be such that the nanoparticles are compatible with and disperse well in the selected solvent.

For ease of control of the two interrelated aspects of the process—the entrainment of nanoparticles and evaporation of the solvent—and/or for efficiency purposes, a nanoparticle dispersion can include two or more solvents having different boiling points or vapor pressures. The higher boiling-point (lower vapor pressure) solvent can be used primarily for controlled evaporation, which can be achieved by applying a vacuum (e.g., through a vacuum pump connected to a chamber which encloses the reservoir and microchannels), the degree of which can be adjusted for desired results. In some embodiments, the two or more solvents suitable for the disclosed subject matter can have a vapor pressure range of from about 0.00003 Torr to about 0.01 Torr, and from 1 Torr to about 50 Torr, respectively. In one embodiment, the higher boiling-point solvent has a vapor pressure on the order of 10⁻² Torr or smaller at 25° C. In particular embodiments, a suitable solvent system can include such solvent pairs as xylene and decanol, toluene and dodecanol, or toluene and octadecene.

The ordered assembly of nanoparticles according to the disclosed subject matter can, for example, have a thickness of about at least 3 layers. In certain embodiments, the ordered assembly of nanoparticles can be 100 layers or greater. The number of layers or thickness of the ordered assembly can be varied and/or adjusted by varying the preparation parameters, such as the types and/or concentration of nanoparticles, solvent, operating temperature, and the dimension and configuration of the reservoir and the microchannels. In some embodiments, the ordered assembly of nanoparticles can have a multilayered structure, wherein the nanoparticles in at least one of the multilayers are ordered as hexagonal AB-packing.

The disclosed subject matter is also directed to the ordered assembly of nanoparticles formed using the above-described techniques, and devices based thereupon.

The ability to fabricate superlattices having about 100 or more layers with lateral dimensions up to about 1 μm provides opportunities for diverse optical, electronic, magnetic, and mechanical investigations of their emergent collective properties and applications. For example, with periodicities on the length-scale of X-ray wavelengths, the superlattices can be used as X-ray optical materials, including waveguides, diffraction gratings, and possibly negative-index materials (waveguides in particular can be useful as they would be highly wavelength-dependent and can be useful in X-ray detection or signal-propagation technologies). As the periodicity in the superlattices is also on the length-scale of magnetic moments and domains, the superlattices can be used to engineer materials having strongly-anisotropic or non-traditional soft magnetization behavior for improving magnetic storage media.

In an anisotropic crystal structure, as in a binary nanoparticle superlattice, the mechanical properties of the superlattices, which arise from strength of steric interactions between ligands and particle-particle interactions, such as Van der Waals, will also be anisotropic. Therefore, binary nanoparticle superlattices have applications for vibration/sonic detection devices. The microchannel design of the disclosed subject matter allows precise engineering of the vibrational response of the superlattice material, and permits its integration in on-chip devices.

In other embodiments, the superlattices can include reactive nanoparticle species or other reactant to be used to initiate, control, or catalyze chemical reactions. This leads to an open 3D structure which is useful on its own and as a substrate for further chemical reactions.

Using a combination of semiconducting and noble-metal nanoparticles, novel negative-index materials can be designed whose properties depend on nanometer-scale periodic ordering of the particles in three dimensions. Therefore, in certain embodiments, the methods disclosed in the present application can permit these materials to be fabricated quickly, controllably, and in predetermined geometries and locations on-chip. The ordered assemblies of nanoparticles also have applications as photonic band gap materials for optoelectronics either as a template with the interstitial regions filled or with hollow nanoparticles.

The emerging fields of plasmonics-based subwavelength optics requires the fabrication of arrays of plasmonic units with a period of nanometers. This type of array places high demands on traditional top-down lithographic methods, while the nanoparticle supercrystals of the present application can serve as a competitive alternative for the fabrication of such devices, with relatively low cost and the possibility of scale-up.

Superlattice materials can also act, for example, as novel magnetoresistive systems and can also be used as memristor components. With conductive ligands on the nanoparticles, nanoparticle supercrystals can provide a system with highly controllable properties for these applications. The ability to define geometry and location provided by the techniques disclosed herein is important to the realization of these applications.

### EXAMPLE

The disclosed subject matter is further described by means of the example presented below, which is for illustrative purpose only and in no way limits the scope and meaning of the disclosed subject matter or of any exemplified term. Likewise, the disclosed subject matter is not limited to any particular embodiments described herein as many modifications and variations of the disclosed subject matter will be apparent to those skilled in the art upon reading this specification.

The following example illustrates the formation of large 3D supercrystals of nanoparticles by controlling solvent evaporation in a lithographically defined structure in which a nanoparticle dispersion is entrained into microchannels. In short, a drop of a nanoparticle dispersion containing either CdSe or Fe₂O₃ nanoparticles dispersed in a high-boiling-point/low-boiling point two-solvent system was placed into a central reservoir and entrained into a series of long, narrow microchannels as the solvents evaporate. Ordered growth of supercrystals occurs during the evaporation of the high boiling point (bp) solvent, assisted by vacuum pumping, over a period of time. The controlled evaporation of the solvent allows for crystallization of the nanoparticles.

### (i). Nanoparticles Synthesis

CdSe nanoparticles were prepared as follows: 102.8 mg of CdO, 910 mg of stearic acid and 32 mL of octadecene was mixed in a 120 mL three-necked flask. The mixture was heated at 250° C. for 10 minutes to allow the formation of cadmium stearate.

Then 4 g of trioctylphosphine oxide and 4 g of octadecylamine were added and followed by degassing. The mixture was then heated to 300° C., and a 4 mL solution of 1.0 M trioctylphosphine selenide in trioctylphosphine was injected quickly. The growth was carried out at 280° C. The CdSe nanoparticles thus prepared are believed to include a coating or stabilizing shell of trioctylphosphine oxide.

Fe₂O₃ nanoparticles were synthesized as follows: A mixture of 10 mL octyl ether and 2.14 mL oleic acid was degassed at 100° C. for 1 hour, followed by injection of 0.2 mL iron pentacarbonyl. The mixture was heated to 280° C. and held at this temperature for 1 hour. The Fe₂O₃ nanoparticles thus prepared are believed to include a coating or stabilizing shell of oleate.

Both CdSe and Fe₂O₃ nanoparticle products were purified with ethanol/toluene as a nonsolvent/solvent pair. Core diameters (or average size) were determined by TEM, and for CdSe nanoparticles also by luminescence. The average size of Fe₂O₃ nanoparticles and CdSe nanoparticles thus prepared was determined to be about 8.0 nm and 5.5 nm, respectively. All Fe₂O₃ and CdSe particles were monodisperse (5% variation in core diameter) and crystalline, as determined by x-ray and electron diffraction. All chemicals used in the above preparations were purchased from Sigma-Aldrich (St. Louis, Mo.).

### (ii). Preparation of Reservoir and Microchannels

Lithographic techniques were used to prepare the reservoir and the microchannels. Si <100> wafers were patterned with chrome etch masks by conventional electron-beam lithography techniques (PMMA resist deposition, followed by exposure to the electron beam, development in methyl isobutyl ketone, thermally-evaporated chrome deposition, and resist liftoff). The wafers were then etched in two steps using an inductively-coupled plasma (Oxford Plasmalab 80 Plus ICP) system, using a technique generally known as an Advanced Silicon Etch. First, the wafers were etched with a mixture of C₄F₈ and 0₂ for 30 seconds, to remove any native oxides formed during exposure to air. Next, a two-step anisotropic silicon etch was performed. In the first step, a low-power (50 W) plasma of C₄F₈ was applied for 5 seconds, producing a passivation layer on the surface of the silicon substrate. Then, a 30 second, high-power (300 W) plasma of SF₆ was applied to rapidly etch away silicon around the chrome mask pattern. The resulting sample substrate consisted of a 1.2 μm high wall of silicon in the shape of the chrome etch mask. The sample surface was found to be hydrophobic following the etch process; the as-fabricated samples were stored in a dry box to prevent contamination.

Two alternative configurations of reservoir/microchannel were prepared, as illustrated in FIG. 2. FIG. 2a shows a SEM micrograph of a reservoir/channel configuration consisting of a ˜500 μm central reservoir with several microchannels (typically 4-8) extending radially from the perimeter, with the microchannel magnified in the inset (scale bar of 10 μm). FIG. 2b shows a SEM micrograph of a reservoir/channel pattern used for small-angle X-ray scattering measurements which places large numbers of microchannels in parallel to improve signal-to-noise ratio, with an inset showing the region typically analyzed by X-ray scattering (schematic, not drawn to scale).

(iii). Formation of Ordered Assembly of Nanoparticles:

Nanoparticle dispersions (˜10¹⁵ NPs/mL) of either Fe₂O₃ or CdSe in a solvent system consisting of decanol in xylene (vol % of decanol is 3% of that of xylene) were prepared. The dispersions were injected into the reservoir on the substrate using a microinjector (Narishige IM-300) until the reservoir was filled. The sample was then allowed to sit in air in ambient conditions for ˜20 minutes while the xylene (bp 140° C.) evaporated. Samples were then placed in a vacuum chamber at ˜100 mTorr in most cases and allowed to dry for 12 hours to assist and control removal of the decanol (bp 230° C.).

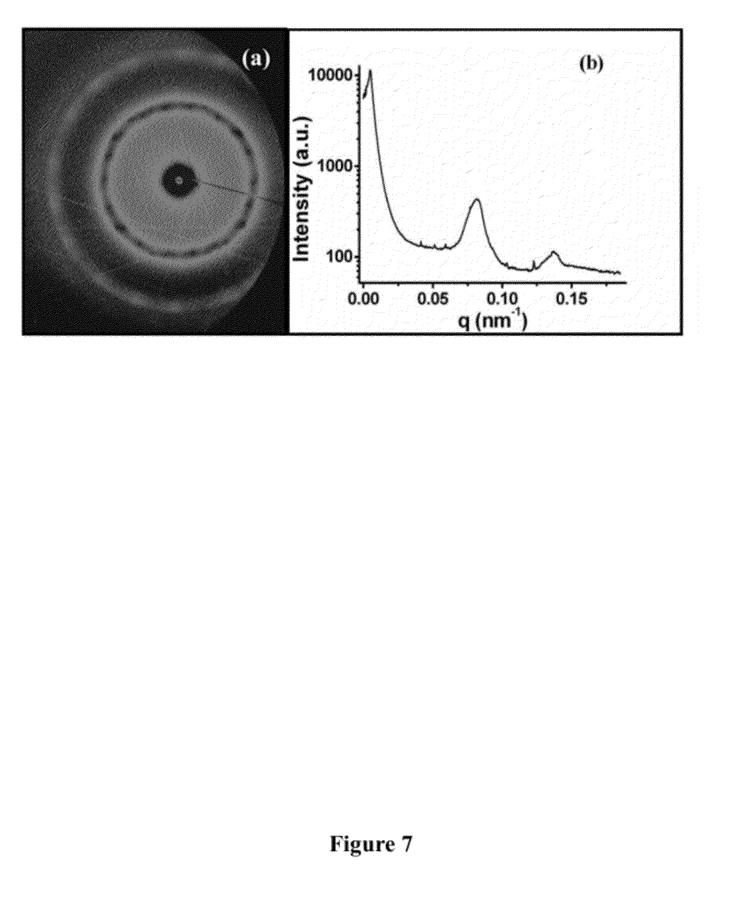

Reflection mode experiments were performed with 0.35° angle of incidence, which is greater than the critical angle of 0.14° for the silicon substrate. The data for the transmission mode experiments (performed at normal incidence) are shown in FIG. 7.

### (iv). Results

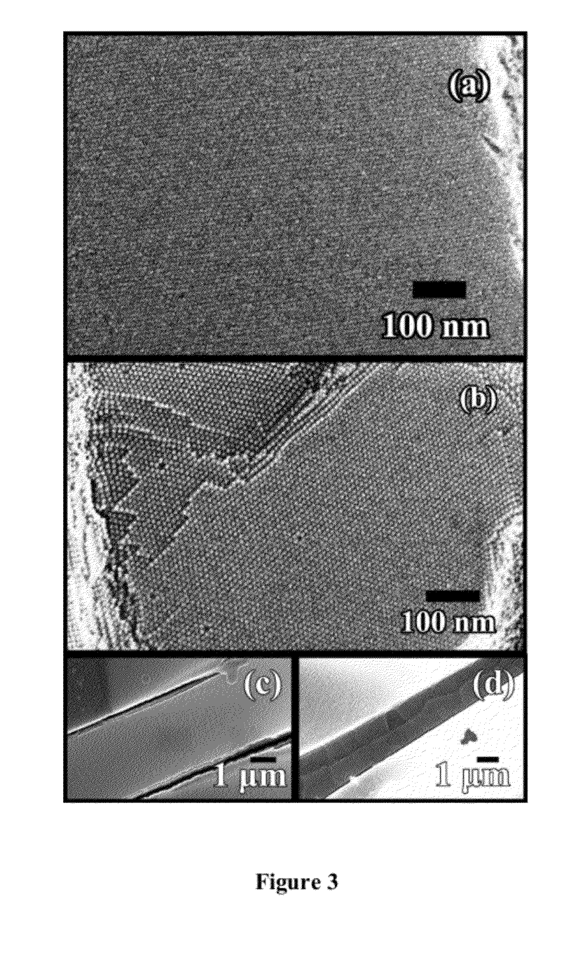

Thick nanoparticle assemblies of about 100 layers were observed in the 1.2 μm deep and 3 μm wide microchannels, and 1-3 layers were seen in the central reservoir, along with multilayer lips about the reservoir periphery. The nanoparticle assembly formed in the microchannels was found to be a highly ordered, multilayer superlattice, by using scanning electron microscopy (SEM) (Hitachi 4700). FIG. 3 depicts the SEM micrographs of the top surface of ordered assemblies of the CdSe nanoparticles (FIG. 3a) and Fe₂O₃ nanoparticles (FIG. 3b), respectively. Hexagonal order of the top surface is evident in both FIGS. 3a and 3b, while in FIG. 3b a number of point defects are observed. Lower magnification SEM micrographs of the superlattices of CdSe nanoparticles (FIG. 3c) and Fe₂O₃ nanoparticle (FIG. 3d) show fractures near and running parallel to the microchannel walls in the former and micrometer-dimension regions in the latter. FIG. 3d also shows contiguous domains of Fe₂O₃ nanoparticles of slightly different heights, leading to grains of highly ordered nanoparticles with lateral dimensions typically about 1 μm. Atomic force microscopy (AFM) (DI Instrument) showed that CdSe nanoparticle superlattice in FIG. 3a were about 790 nm thick and the 8.0 nm Fe₂O₃ nanoparticle assemblies in FIG. 3b were about 950 nm thick.

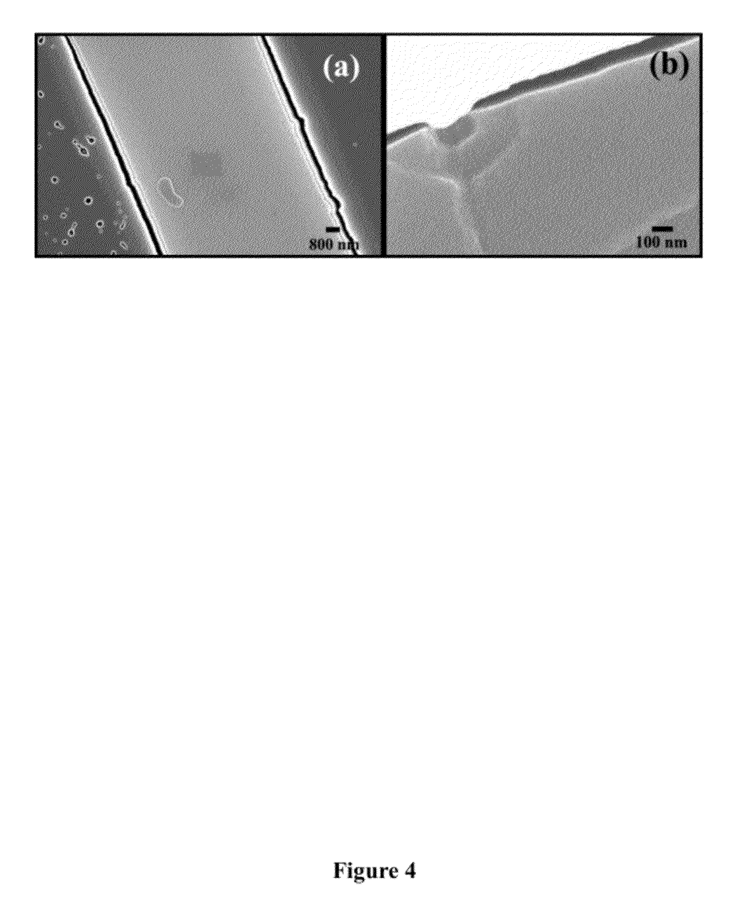

As with FIGS. 3c and 3d, FIG. 4 also shows SEM images depicting cracks between the walls of lithographically-defined microchannel of (a) CdSe nanoparticle superlattice and (b) Fe₂O₃ nanoparticle superlattice. These cracks run along the length of the microchannel, and are believed to have been caused by volume contraction of the supercrystal during solvent evaporation. They are observed to run parallel to the wall of the confining microchannel, closely copying the local morphology of the wall, independent of the local superlattice crystal plane. This suggests that the energy required to cleave the supercrystal is higher than the energy of adhesion between the supercrystal and the microchannel wall.

The microchannels were found to contain a much thicker assembly of nanoparticles than the reservoir, suggesting that an amount of nanoparticles were entrained into the microchannels from the reservoir (only an ˜25 nm thick nanoparticle assembly would form for a microchannel filled to the top with the initial dispersion of nanoparticles after xylene evaporation). In addition, flow into the microchannels appears to be self-limited to a fraction of the microchannel height due to lessening exposure of the microchannel wall, which avoids overfilling of the microchannels.

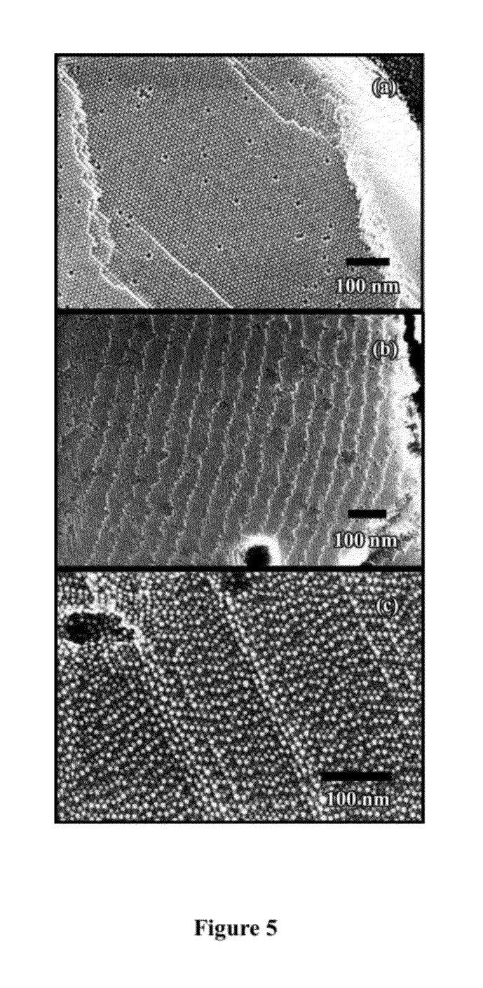

FIG. 5 depicts SEM micrographs of top surfaces of Fe₂O₃ nanoparticle superlattices. SEM of the top surface of the Fe₂O₃ superlattice suggests hexagonal packing of nanoparticles. Some defects and dislocations are observed on the top surface, including point defects (FIGS. 3b and 5), edge dislocations, and screw dislocations (FIG. 5a), which should not significantly affect most collective optical, electronic, and magnetic properties, but can affect mechanical properties. Several samples had small fractional areas with what appears to be hcp <110> planes on the top surface (<5%) (FIG. 5c) or a herringbone type reconstruction (<1%).

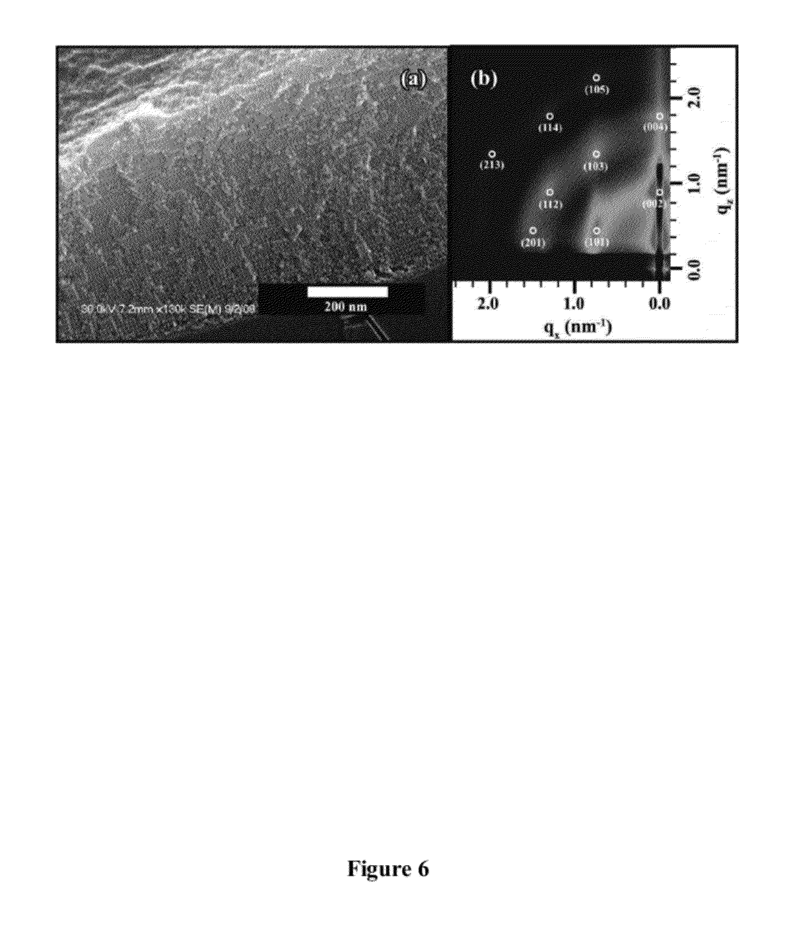

Examination of the terraces on the Fe₂O₃ nanoparticle superlattice surface, across as many as 20 layers, suggests hexagonal AB-stacking ordering with a <001> top surface. Longer range order below the surface of the Fe₂O₃ nanoparticle superlattices was also assessed, as shown in FIG. 6a, which illustrates the microstructure of the interior of ordered assembly of Fe₂O₃ nanoparticles prepared according to the above procedure (FIG. 6a is a SEM micrograph of a cross-sectional view of Fe₂O₃ nanoparticle superlattice, in which the microchannels were scribed across with a diamond wafer scribe). Note that the top of the superlattice was damaged or flaked during cross-sectioning, and the apparent deviation from ordered structure within 1-2 layers of the bottom of the assembly might arise either from initial assembly process and/or the cleaving procedure).

The superlattices of Fe₂O₃ nanoparticles were characterized by small-angle X-ray scattering (SAXS) in reflection mode using 14.5 keV photons (X9 beamline at the National Synchrotron Light Source) (FIG. 6b). To obtain an adequate signal-to-noise ratio, samples with many (about 160) parallel microchannels as shown in FIG. 2b filled with supercrystals were probed by the about 0.2 mm×0.3 mm beam. The thick superlattice is highly ordered, and has hexagonal AB-stacking structure (space group P6₃/mmc) with a=b=9.7±0.1 nm and c=14.0±0.1 nm lattice constants (which is consistent with the SEMs). This is similar to hcp but with uniaxial lattice compression (11%) in the c-axis; the deviation from hcp can be due to volume loss during solvent evaporation. In addition to rings expected from a sample of randomly oriented crystal grains, peaks were observed indicating preferential alignment of the supercrystals with their <001> planes parallel to the substrate. Transmission SAXS measurements confirmed the high degree of transverse hexagonal ordering. (See FIG. 7. FIG. 7a shows the scattering pattern having rings typical of powder-type diffraction, and FIG. 7b shows a graph of a one-dimensional trace across the transmission data. The first peak corresponds to the (100) plane with a lattice parameter of a=9.7 nm.) Though the hcp structure is energetically less favored than fcc for hard sphere packing, hcp type AB stacking has been observed in other studies of nanoparticle superlattice formation, likely because of interactions between the nanoparticle cores, including dipole-dipole interactions.

Control of the design of the microchannels, drying rate, and nanoparticle concentration in the dispersion provides an opportunity to control fluid flow into the microchannels and the growth kinetics that determine the degree of order. For example, for Fe₂O₃ nanoparticles, increasing the microchannel width beyond 4 μm led to very small polycrystalline grains, while increasing it beyond about 8 μm (while maintaining the same depth of the microchannels) led to little fluid entrainment into the microchannels. It is believed that this can be attributed to the reduced area of side walls as compared to the bottom surface of the microchannels, which results in a reduction in the effect of capillary action.

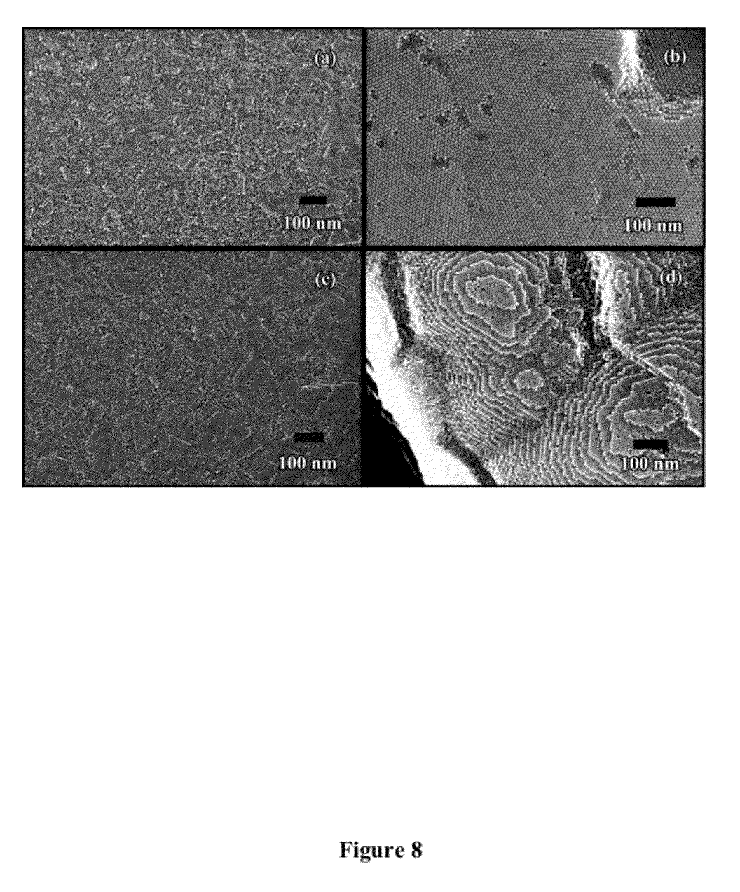

FIGS. 8a-8d depict the SEM micrographs of top surface of Fe₂O₃ nanoparticle assembly (formed in the microchannel configuration illustrated in FIG. 2b) obtained from experiments using different solvent evaporation rates and the starting nanoparticles concentrations. (a) Lower base pressure during drying (˜100 mTorr), ˜10¹⁵ NPs/mL, which led to polycrystalline/amorphous order, (b) higher base pressure during drying (25 Torr air), ˜10¹⁵ NPs/mL, which led to large supercrystal grains, (c) initial nanoparticle concentration, ˜10¹⁴ NPs/mL (much lower than the ˜10¹⁵ NPs/mL standard in FIGS. 3b, 3d, 5, and 6), which led to polycrystalline order, (d) initial nanoparticle concentration, ˜10¹⁶ NPs/mL (much higher than the ˜10¹⁵ NPs/mL standard), which led to columnar grains that are highly ordered. It can be seen from FIG. 8 that slowing the rate of solvent (here decanol) evaporation by increasing the pressure in the chamber improved the degree of order from amorphous assembly at lower pressures to ordered assembly at higher pressures (˜25 Torr). Increasing the nanoparticle concentration in the dispersion changed the superlattice structure, for the microchannel configuration in FIG. 2a, from one with no long range order [disordered (amorphous) or locally ordered (polycrystalline) regions] (FIG. 8c) for ˜10¹⁴ NPs/mL (in the 3% deconal/xylene solution), to one with a very high degree of hexagonal AB-stacking order for ˜10¹⁵ NPs/mL (FIGS. 3b, 5, 6a), and then to one with columnar structures of locally hexagonal AB-stacking ordered regions (FIG. 8d) for ˜10¹⁶ NPs/mL. Assembly formed using ˜10¹⁴ Fe₂O₃ NPs/mL (FIG. 8c) were almost as thick (790 nm), though less densely packed, as those formed with ˜10¹⁵ NPs/mL (and the lip of nanoparticles was significantly narrower), which is further evidence for self-limiting flow during drying.

It appears that the microchannel geometry determines the shape and position of the supercrystal by confining the solvent and nanoparticles during drying, but the final size of the supercrystal is smaller than the microchannel and is determined by the volume contraction during the final stage of solvent evaporation.

The above results are highly repeatable, making systematic optimization and investigation of the formation mechanism possible. These results demonstrate that the microfluidics techniques of the disclosed subject matter provide more precise control of the immediate environment necessary to prescribe the superlattice formation conditions and improve repeatability.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous systems and methods which, although not explicitly shown or described herein, embody the principles of the disclosed subject matter and are thus within its spirit and scope.

What is claimed is:

1. A method for forming an ordered assembly of nanoparticles in at least one microchannel, comprising:
introducing a volume of a nanoparticle dispersion into a reservoir, the nanoparticle dispersion including nanoparticles and at least one solvent, wherein the reservoir is in fluidic communication with at least one microchannel;
permitting at least a portion of the dispersion including the nanoparticles to move into the at least one microchannel; and
controlling the evaporation rate of the at least one solvent in the dispersion to form the ordered assembly of nanoparticles in the at least one microchannel.

2. The method of claim 1, wherein the controlling comprises controlling the evaporation rate to form an ordered assembly of nanoparticles having a thickness of at least about 100 layers.

3. The method of claim 1, wherein the nanoparticles include Fe₂O₃ nanoparticles and/or CdSe nanoparticles.

4. The method of claim 1, wherein the controlling comprises controlling the evaporation rate to form an ordered assembly of nanoparticles having two or more layers, wherein at least one of the two or more layers form a hexagonal AB-packing.

5. The method of claim 1, wherein the introducing includes introducing nanoparticles having an average size of about 1 to about 50 nm in diameter.

6. The method of claim 1, wherein the introducing includes introducing nanoparticles having a substantially spherical shape.

7. The method of claim 1, wherein the introducing includes introducing nanoparticles monodisperse in size.

8. The method of claim 1, wherein the introducing includes introducing nanoparticles having a concentration of at least about 10¹⁵ nanoparticles / mL.

9. The method of claim 1, wherein the controlling comprises applying a vacuum.

10. The method of claim 1, wherein the introducing includes introducing at least one solvent having a boiling point of about 200° C. or higher at atmospheric pressure.

11. The method of claim 1, wherein the introducing includes introducing at least two solvents, the at least two solvents having different boiling points.

12. The method of claim 11, wherein one of the at least two solvents having the higher boiling point has a vapor pressure of 10⁻² Torr or lower at 25° C.

13. The method of claim 11, wherein the at least two solvents each have a vapor pressure of from about 0.00003 Torr to about 0.01 Torr and from about 1 Torr to about 50 Torr, respectively.

14. An apparatus for preparing an ordered assembly of nanoparticles using a volume of a nanoparticles dispersion, comprising:
a reservoir for receiving the volume of the nanoparticles dispersion;
at least one microchannel,
wherein the at least one microchannel is configured for fluidic communication with the reservoir and to cause at least a portion of the nanoparticles in the nanoparticles dispersion received in the reservoir to move into the at least one microchannel and to form an ordered assembly therein.

15. The apparatus of claim 14, wherein the at least one microchannel has a depth of from about 1.0 microns to about 3.0 microns.

16. The apparatus of claim 14, wherein the at least one microchannel has a width of from about 0.5 microns to about 20 microns.

17. The apparatus of claim 14, wherein the reservoir and the at least one microchannel are both manufactured by lithography.

18. The apparatus of claim 14, wherein the reservoir and the at least one microchannel are both manufactured on a silicon wafer.

19. The apparatus of claim 14, wherein the at least one microchannel includes a plurality of microchannels distributed on the periphery of the reservoir.

20. The apparatus of claim 14, further comprising a chamber enclosing the reservoir and the at least one microchannel, the chamber being able to provide a lower pressure than atmospheric pressure.

21. The apparatus of claim 20, wherein the chamber is connected with a vacuum providing device.

22. An ordered assembly of nanoparticles having a thickness of at least about 100 layers or greater, and a width of about 0.1 microns to about 200 microns.

23. An ordered assembly of nanoparticles made by the method of claim 1.
